(19) United States
(12) Patent Application Publication
(10) Pub. No.: US 2018/0077312 A1
(43) Pub. Date: Mar. 15, 2018

(54) IMAGE READING APPARATUS AND IMAGE READING METHOD

(71) Applicants: KABUSHIKI KAISHA TOSHIBA, Tokyo (JP); TOSHIBA TEC KABUSHIKI KAISHA, Tokyo (JP)

(72) Inventors: Naoya Koseki, Sunto Shizuoka (JP); Yusuke Hashizume, Urayasu Chiba (JP)

(21) Appl. No.: 15/264,811

(22) Filed: Sep. 14, 2016

(51) Int. Cl. H04N 1/053; H04N 1/047; H04N 1/10

(52) U.S. Cl. CPC H04N 1/053; H04N 1/0473; H04N 2201/0081; H04N 1/1035; H04N 2201/04755; H04N 1/1043

(57) ABSTRACT

In accordance with an embodiment, an image reading apparatus comprises a carriage, a stepping motor and a processor. The carriage acquires an image. The stepping motor moves the carriage. The processor outputs a first clock signal for driving the stepping motor if a present position of the carriage is unknown and outputs a second clock signal, of which a frequency is higher than that of the first clock signal, for driving the stepping motor if the present position of the carriage can be recognized.

### FIELD

Embodiments described herein relate generally to an image reading apparatus and an image reading method.

### BACKGROUND

There is an image reading apparatus such as a scanner for moving a carriage to read a document. The image reading apparatus which moves the carriage to read the document includes a stepping motor for moving the carriage.

A CPU of the image reading apparatus supplies a clock to the stepping motor to control the stepping motor. The stepping motor rotates at a high speed as a high clock is supplied thereto and can move the carriage at the high speed.

As an upper limit is set for the number of clocks supplied to closed loop control by the CPU, conventionally, there is a problem that a moving speed of the carriage is restricted in the image reading apparatus.

### DESCRIPTION OF THE DRAWINGS

FIG. 1 is a diagram illustrating an example of the configuration of an image reading apparatus according to an embodiment;

FIG. 2 is a block diagram illustrating an example of the configuration of a driving control section according to the embodiment;

FIG. 3 is a table illustrating an example of clocks input to a driver according to the embodiment; and

FIG. 4 is a timing chart of signals output by a CPU according to the embodiment.

### DETAILED DESCRIPTION

In accordance with an embodiment, an image reading apparatus comprises a carriage, a stepping motor and a processor. The carriage acquires an image. The stepping motor moves the carriage. The processor outputs a first clock signal for driving the stepping motor if a present position of the carriage is unknown and outputs a second clock signal, of which a frequency is higher than that of the first clock signal, for driving the stepping motor if the present position of the carriage can be recognized.

Hereinafter, the embodiment is described with reference to the accompanying drawings.

An image reading apparatus according to the embodiment reads an image from a document. The image reading apparatus is equipped with a carriage for reading the image in a main scanning direction. The image reading apparatus moves the carriage in a sub-scanning direction orthogonal to the main scanning direction to read images of the whole document.

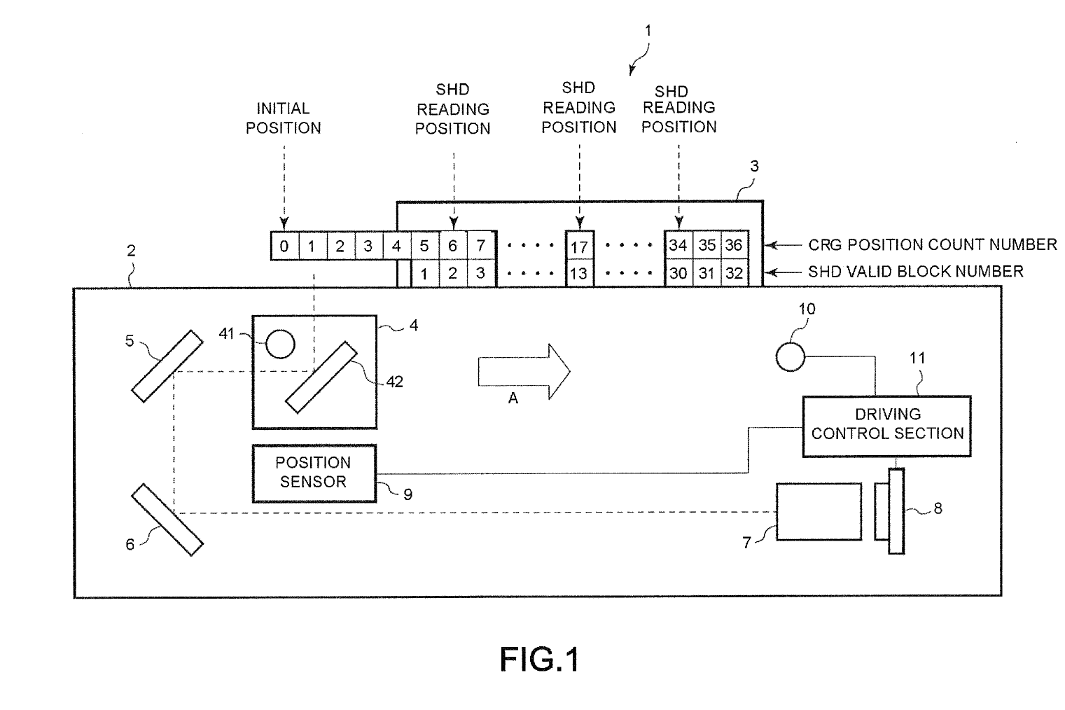

FIG. 1 is a diagram illustrating an example of the configuration of an image reading apparatus 1.

As shown in FIG. 1, the image reading apparatus 1 is equipped with a casing 2, a shading plate 3, a carriage (CRG) 4, a mirror 5, a mirror 6, a lens 7, an image sensor 8, a position sensor 9, a stepping motor 10 and a driving control section 11.

The casing 2 constitutes an outline of the image reading apparatus 1.

The shading plate 3 is a member for supplying reference data of shading correction of an image read by the image sensor 8. For example, the shading plate 3 is a member having a color serving as reference of the shading correction. For example, the shading plate 3 is a white plate formed into a rectangular shape.

The shading plate 3 is formed in the main scanning direction in which the carriage 4 reads the image. In other words, the shading plate 3 is formed in a direction orthogonal to FIG. 1. The shading plate 3 is formed in such a manner that the shading plate 3 in the main scanning direction is wider than a width of the image acquired by the image sensor 8 in the main scanning direction. The shading plate 3 is formed on the casing 2. Further, the shading plate 3 may be formed in the casing 2.

The carriage 4 acquires the image in the main scanning direction orthogonal to FIG. 1. The carriage 4 acquires light in the main scanning direction and reflects the acquired light to the mirror 5. The carriage 4 is formed in the casing 2 and moves along an upper surface of the casing 2 in the sub-scanning direction (A direction). The carriage 4 is formed at a position at which the light reflected from the shading plate 3 and the document can be acquired at the time of passing through the shading plate 3 and the document.

The carriage 4 is composed of a light source 41 and a mirror 42.

The light source 41 emits the light with which the shading plate 3 and the document are irradiated. For example, the light source 41 is composed of an LED or a fluorescent light.

The mirror 42 reflects the light from a predetermined area to the mirror 5 at a predetermined angle. The mirror 42 is formed in the carriage 4 at a predetermined angle. Herein, the mirror 42 reflects the light in a direction opposite to the direction A.

Further, the carriage 4 may include a reflector for concentrating the light in a predetermined area. The carriage 4 may properly add a necessary component, or delete an unnecessary component.

The mirror 5 reflects the light from the carriage 4 to the mirror 6. The mirror 5 is arranged at a height approximately same as the mirror 42. Herein, the mirror 5 reflects the light from the mirror 42 downwards.

The mirror 6 reflects the light from the mirror 5 to the lens 7. The mirror 6 is formed almost just under the mirror 5. Herein, the mirror 6 reflects the light from the mirror 5 approximately parallel to the direction A.

The lens 7 enables the light from the mirror 6 to form an image on the image sensor 8. The lens 7 is arranged at a position approximately parallel to the mirror 6.

The image sensor 8 converts the light from the lens 7 to an electrical signal. For example, the image sensor 8 is constituted by a plurality of photoelectric conversion elements corresponding to reading pixels in the main scanning direction. Each of the photoelectric conversion elements of the image sensor 8 generates a signal corresponding to intensity of the light and transmits the signal to the driving control section 11.

The position sensor 9 detects the position of the carriage 4. For example, the position sensor 9 detects whether there is the carriage 4 at a predetermined position. In the embodiment, the position sensor 9 detects whether the carriage 4 is located at a predetermined initial position.

For example, the position sensor 9 may be composed of an optical sensor. The position sensor 9 may be constituted by a switch for detecting the position by contacting with the carriage 4. The configuration of the position sensor 9 is not limited to the specific configuration.

The stepping motor 10 is a drive section for moving the carriage 4. For example, a rotation shaft of the stepping motor 10 is connected with the carriage 4 via a gear or a belt. If the stepping motor 10 is driven, the carriage 4 is moved.

The driving control section 11 controls movement of the carriage 4. In other words, the driving control section 11 controls the drive of the stepping motor 10. For example, the driving control section 11 supplies a pulse signal to the stepping motor 10 to control the drive of the stepping motor 10. The driving control section 11 is described in detail later.

Incidentally, the image reading apparatus 1 may properly add a necessary component, or may delete an unnecessary component.

In FIG. 1, a CRG position count number represents the number of clocks to be supplied to the stepping motor 10 for moving the carriage 4 from the initial position. In other words, if the driving control section 11 supplies 10 clocks to the stepping motor 10, the carriage 4 is moved to a position indicated by “10”.

A shading correction process (SHD) valid block number represents a position at which the shading plate 3 is positioned. In the example shown in FIG. 1, the shading plate 3 is positioned in a range in which the CRG position count number is from “5” to “36”, for example.

Next, an example of the configuration of the driving control section 11 is described.

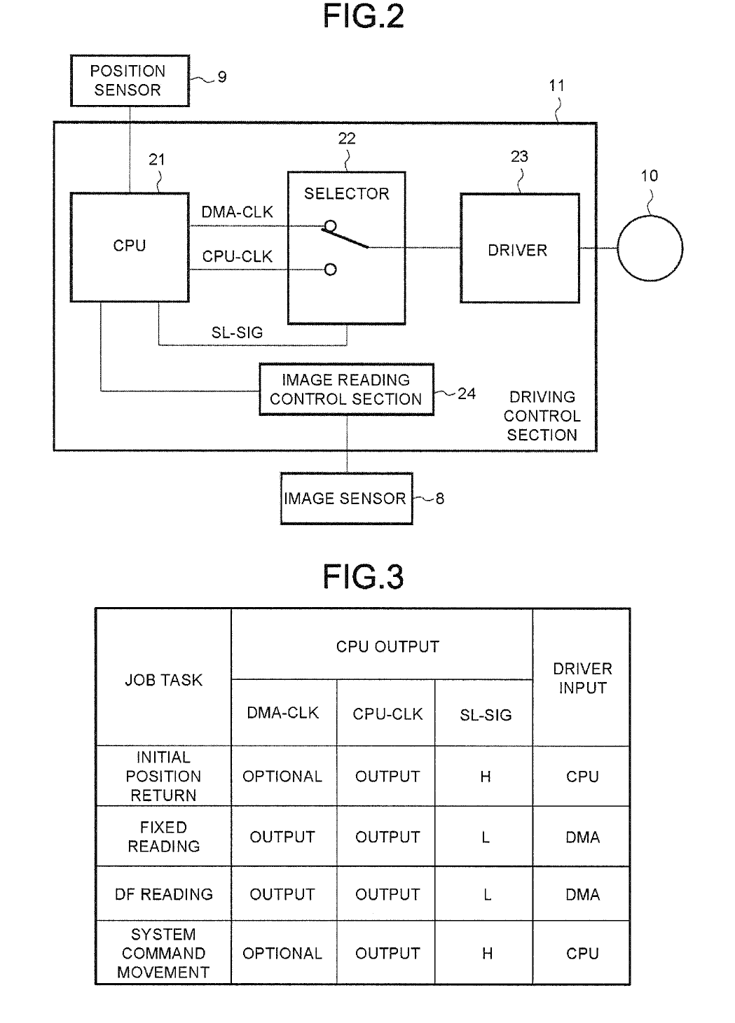

FIG. 2 is a block diagram illustrating an example of the configuration of the driving control section 11.

As shown in FIG. 2, the driving control section 11 is equipped with a CPU 21, a selector 22, a driver 23 and an image reading control section 24.

The CPU 21 controls the whole driving control section 11. The CPU 21 may include an internal cache and various interfaces. The CPU 21 realizes various processing through executing programs stored in an internal memory or an external memory in advance. The CPU 21 is, for example, a processor.

Further, a portion of various functions realized by executing the programs by the CPU 21 may be realized through a hardware circuit. In this case, the CPU 21 controls the functions realized through the hardware circuit.

The CPU 21 outputs a CPU clock signal (CPU-CLK) (first clock) and a DMA (Direct Memory Access) clock signal (DMA-CLK) (second clock) for driving the stepping motor 10.

The CPU clock is used in closed loop control. In other words, the CPU 21 outputs the CPU clock signal for realizing the closed loop control. The CPU 21 can start or stop the output of the CPU clock in response to a signal from the outside.

The DMA clock is used in open loop control. In other words, the CPU 21 outputs the DMA clock signal for realizing the open loop control. The CPU 21 sets the number and a cycle (configuration) of the output clocks to output the DMA clock signal. The frequency of the DMA clock signal is higher than that of the CPU clock signal.

The CPU 21 supplies a selection signal (SL-SIG) to the selector 22. The selection signal indicates which clock signal of the CPU clock signal and the DMA clock signal is supplied to the driver 23. For example, if the selection signal is “High”, the CPU clock signal is supplied to the driver 23. Contrarily, if the selection signal is “Low”, the DAM clock signal is supplied to the driver 23.

The CPU 21 supplies a synchronization signal to the image reading control section 24. The synchronization signal instructs reading of the image to the image reading control section 24. For example, if the synchronization signal is “High”, the synchronization signal instructs the image reading control section 24 to read the image. Contrarily, if the synchronization signal is “Low”, the synchronization signal instructs the image reading control section 24 to stop the reading of the image.

The selector 22 supplies either of the CPU clock signal and the DMA clock signal output by the CPU 21 to the driver 23. The selector 22 supplies the CPU clock signal or the DMA clock signal to the driver 23 according to the selection signal (SL-SIG) from the CPU 21. For example, the selector 22 supplies the CPU clock signal to the driver 23 if the selection signal is “High”. Contrarily, the selector 22 supplies the DMA clock signal to the driver 23 if the selection signal is “Low”.

The driver 23 supplies the pulse signal to the stepping motor 10 according to either of the CPU clock signal and the DMA clock signal supplied from the selector 22. For example, the driver 23 supplies a signal generated by amplifying either of the CPU clock and the DMA clock supplied from the selector 22 to a predetermined voltage to the stepping motor 10 as the pulse signal.

The image reading control section 24 processes image data from the image sensor 8 based on the synchronization signal from the CPU 21. For example, the image reading control section 24 processes the image data from the image sensor 8 and sends the processed image data to the outside if the synchronization signal is “High”. Contrarily, the image reading control section 24 stands by if the synchronization signal is “Low”.

Next, an example of operations of the CPU 21 is described.

FIG. 3 is a table illustrating an example of the operations of the CPU 21.

First, the operations for returning the carriage 4 to the initial position (initial position return operation) by the CPU 21 are described.

Herein, the present position of the carriage 4 is assumed to be unknown.

As shown in FIG. 3, in the initial position return operation, the CPU 21 supplies the CPU clock signal to the selector 22. Further, the CPU 21 may not supply the DMA clock signal to the selector 22. Further, the CPU 21 supplies “High” as the selection signal to the selector 22.

The selector 22 receives “High” as the selection signal from the CPU 21. If receiving “High” as the selection signal, the selector 22 supplies the CPU clock signal from the CPU 21 to the driver 23.

The driver 23 supplies the pulse signal according to the CPU clock to the stepping motor 10. The stepping motor 10 is driven according to the pulse signal. If the stepping motor 10 is driven, the carriage 4 is moved in a predetermined direction (A direction or a direction opposite to the A direction) according to the rotation of the stepping motor 10.

The CPU 21 determines whether a signal (detection signal) indicating that the carriage 4 is detected is received from the position sensor 9 during the movement of the carriage 4. In other words, the CPU 21 determines whether the carriage 4 is moved to the initial position.

The CPU 21 enables the carriage 4 to move until the detection signal is received. In other words, the CPU 21 continues the output of the CPU clock signal. The CPU 21 stops the supply of the CPU clock signal to the driver 23 if receiving the detection signal. In other words, the CPU 21 stops the carriage 4. Further, the CPU 21 may send a signal to the driver 23 to stop the supply of the pulse signal to the stepping motor 10.

Through the foregoing operations, the CPU 21 returns the carriage 4 to the predetermined initial position.

Next, fixed reading operations for reading the document on the casing 2 by the CPU 21 are described.

Herein, the document is positioned at a position in the A direction with respect to the shading plate 3 on the casing 2. The carriage 4 is positioned at the initial position. In other words, the CPU 21 can recognize the present position of the carriage 4.

The CPU 21 can read the shading plate 3. As shown in FIG. 1, the CPU 21 reads the shading plate 3 at positions where the CRG position count numbers are “6” “17” and “34”, for example.

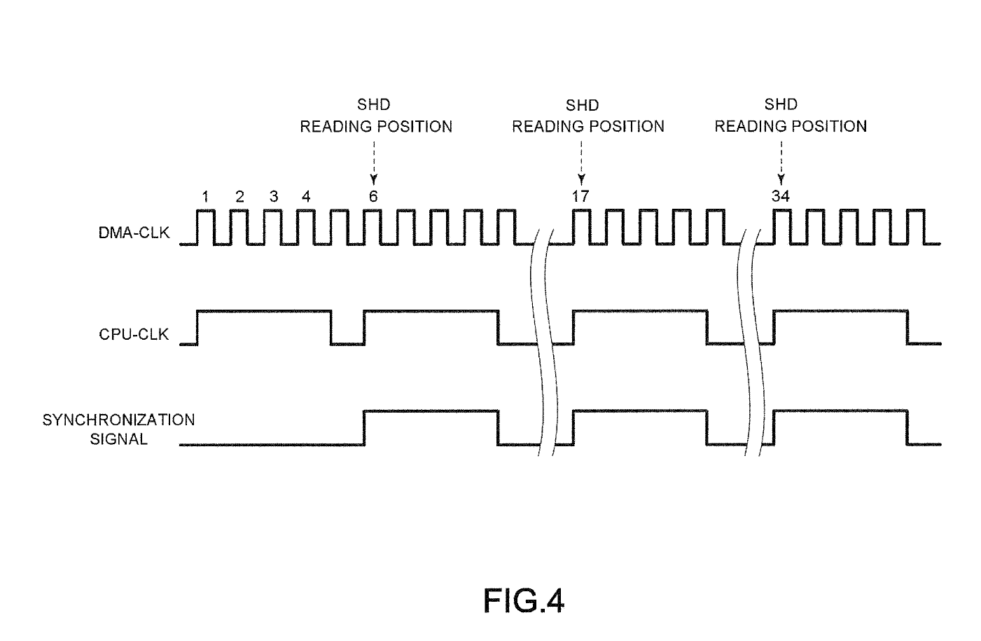

FIG. 4 is a timing chart illustrating signals in a case in which the CPU 21 reads the shading plate 3. The timing chart shown in FIG. 4 shows the DMA clock signal, the CPU clock signal and the synchronization signal output by the CPU 21.

First, the CPU 21 sets the configuration (for example, cycle and number) of the output DMA clock signal. For example, the CPU 21 sets the configuration of the DMA clock f signal or enabling the carriage 4 to move from the initial position to positions at which the reading of the shading plate 3 and the document is terminated. The CPU 21 supplies “Low” as the selection signal to the selector 22.

If the configuration of the DMA clock is set, the CPU 21 outputs the DMA clock signal to the selector 22 in accordance with the set configuration.

The selector 22 outputs the DMA clock signal output by the CPU 21 to the driver 23 according to the selection signal.

The driver 23 supplies the pulse signal to the stepping motor 10 based on the DMA clock. The stepping motor 10 is driven according to the pulse signal. If the stepping motor 10 is driven, the carriage 4 is moved in the A direction in response to the rotation of the stepping motor 10.

The CPU 21 outputs (generates) the CPU clock signal. The CPU 21 counts the CPU clock to determine the position of the carriage 4. For example, the CPU 21 starts to count the CPU clock at a timing at which the DMA clock is supplied to the driver 23.

The CPU 21 determines whether the carriage 4 is positioned at the reading position of the shading plate 3. For example, the CPU 21 determines whether the carriage 4 is positioned at the reading position of the shading plate 3 based on the number of the counted CPU clock signals.

The CPU 21 determines whether the count number is coincident with a count threshold value to determine whether the carriage 4 is positioned at the reading position of the shading plate 3. The count threshold value refers to the number of the output CPU clock signals corresponding to the reading position of the shading plate 3. In other words, the count threshold value refers to the number of the output CPU clock signals counted at a timing at which the CPU 21 outputs the DMA clock signal number (for example, “6”, “17” or “34”) corresponding to the reading position of the shading plate 3. Further, the count threshold value may be stored in a memory in advance.

The CPU 21 determines that the carriage 4 is positioned at the reading position of the shading plate 3 if it is determined that the number of the counted CPU clock signals is coincident with the count threshold value. In the example shown in FIG. 4, the CPU 21 determines that the carriage 4 is positioned at the reading position of the shading plate 3 at a timing at which the DMA clock signal number is “6”, “17” or “34” (in other words, a timing at which the number of the CPU clock signals reaches the count threshold value).

If it is determined that the carriage 4 is positioned at the reading position of the shading plate 3, the CPU 21 outputs the synchronization signal for instructing the reading of the image to the image reading control section 24. In other words, the CPU 21 outputs “High” as the synchronization signal to the image reading control section 24. The CPU 21 continues the period in which the shading plate 3 can be read at the reading position and outputs “High” as the synchronization signal to the image reading control section 24. For example, the CPU 21 outputs “Low” as the synchronization signal at a timing at which the pulse of the CPU clock falls.

As shown in FIG. 4, the CPU 21 outputs “High” as the synchronization signal to the image reading control section 24 at a timing at which the DMA clock signal number is “6”, “17” or “34”, for example (in other words, a timing at which the number of the CPU clock signals reaches the count threshold value).

Through the foregoing operations, the CPU 21 reads three positions of the shading plate 3. If reading the shading plate 3, the CPU 21 continues the output of the DMA clock according to the set configuration of the DMA clock to move the carriage 4 to a predetermined position.

Further, the CPU 21 may not set the synchronization signal as “High” simultaneously with the timing at which the carriage 4 passes through the reading position of the shading plate 3 (in other words, in synchronization with the DMA clock of the reading position). In other words, the CPU 21 may output the synchronization signal so that the carriage 4 passes through the reading position of the shading plate 3 during a period in which the synchronization signal is “High”.

The count threshold value is optional as long as the DMA clock of the reading position is contained in the “High” section of the synchronization signal.

Next, an operation (DF reading operation) of reading the document by the CPU 21 with an ADF (auto document feeder) is described.

The carriage 4 is positioned at the initial position. In other words, the CPU 21 can recognize the present position of the carriage 4.

The CPU 21 reads the shading plate 3. The CPU 21 moves the carriage 4 to a position (DF reading position) at which the document sent by the ADF is read after reading the shading plate 3.

FIG. 4 is the timing chart illustrating the signals in a case in which the CPU 21 reads the shading plate 3. The timing chart shown in FIG. 4 shows the DMA clock signal, the CPU clock signal and the synchronization signal output by the CPU 21.

First, the CPU 21 sets the configuration (for example, cycle and number) of the output DMA clock. For example, the CPU 21 sets the configuration of the DMA clock for enabling the carriage 4 to move from the initial position to the shading plate 3 and the DF reading position. The CPU 21 supplies “Low” as the selection signal to the selector 22.

If the configuration of the DMA clock is set, the CPU 21 outputs the DMA clock signal to the selector 22 in accordance with the set configuration.

As the operations of reading the shading plate 3 by the CPU 21 are the same as the fixed reading operations, the description thereof is omitted.

If reading the shading plate 3, the CPU 21 continues the output of the DMA clock signal in accordance with the configuration of the set DMA clock and moves the carriage 4 to the DF reading position.

Next, a system command movement operation is described.

The system command movement operation refers to an operation for enabling the carriage 4 to a predetermined position (for example, a position where the carriage 4 is stored at the time of packing) other than the reading of the image by the CPU 21 or the return to the initial position.

Herein, the CPU 21 cannot recognize the present position of the carriage 4.

As shown in FIG. 3, in the system command movement operation, the CPU 21 supplies the CPU clock signal to the selector 22. Further, the CPU 21 may not supply the DMA clock signal to the selector 22. The CPU 21 supplies “High” as the selection signal to the selector 22.

The selector 22 receives “High” as the selection signal from the CPU 21. If receiving “High” as the selection signal, the selector 22 supplies the CPU clock from the CPU 21 to the driver 23.

The driver 23 supplies the pulse signal according to the CPU clock to the stepping motor 10. The stepping motor 10 is driven according to the pulse signal. If the stepping motor 10 is driven, the carriage 4 is moved in a predetermined direction (A direction or a direction opposite to the A direction) according to the rotation of the stepping motor 10.

The CPU 21 determines whether the carriage 4 is moved to the predetermined position during the movement of the carriage 4. For example, the CPU 21 determines whether the carriage 4 is moved to the predetermined position according to a signal from a sensor for determining whether the carriage 4 is moved to the predetermined position.

The CPU 21 enables the carriage 4 to move until the carriage 4 is moved to the predetermined position. In other words, the CPU 21 continues the output of the CPU clock.

If it is determined that the carriage 4 is moved to the predetermined position, the CPU 21 stops the supply of the CPU clock to the driver 23. In other words, the CPU 21 stops the carriage 4. Further, the CPU 21 may send a signal to the driver 23 to stop the supply of the pulse signal to the stepping motor 10.

Through the foregoing operations, the CPU 21 moves the carriage 4 to the predetermined position.

Further, the CPU 21 may output other clock signals having higher frequencies than the CPU clock instead of the DMA clock. The CPU 21 may receive the input of the DMA clock from an external device.

The image reading apparatus constituted as above moves the carriage with the CPU clock if the present position of the carriage is unknown. The image reading apparatus detects that the carriage is moved to a predetermined position according to the signal from the sensor and stops the movement of the carriage by using the CPU clock.

The image reading apparatus uses the DMA clock to move the carriage if the present position of the carriage can be recognized. As the present position of the carriage can be recognized, the image reading apparatus sets the configuration of the DMA clock to move the carriage to the predetermined position. As the frequency of the DMA clock signal is higher than that of the CPU clock signal, the image reading apparatus can move the carriage to the predetermined position at a high speed.

Further, the image reading apparatus can recognize the position of the carriage by using the CPU clock while moving the carriage by using the DMA clock. As a result, the image reading apparatus can execute predetermined operations if the carriage reaches the predetermined position while the carriage is moved by using the DMA clock.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An image reading apparatus, comprising:
a carriage for acquiring an image;
a stepping motor configured to move the carriage; and
a processor configured to make a first clock signal to be output to drive the stepping motor if a present position of the carriage is not a predetermined position and make a second clock signal to be output to drive the stepping motor if the present position of the carriage is recognized, a frequency being higher than that of the first clock signal.

2. The image reading apparatus according to claim 1, wherein
the first clock signal is used in a closed loop control; and
the second clock signal is used in an open loop control.

3. The image reading apparatus according to claim 1, wherein
the processor sets the configuration of a second clock and outputs the second clock signal in accordance with the configuration.

4. The image reading apparatus according to claim 1, wherein
the processor generates the first clock signal, counts the first clock signal and executes predetermined operations if the count number of the first clock signals is coincident with a predetermined count threshold value during the output of the second clock signal.

5. The image reading apparatus according to claim 4, wherein
the predetermined operations comprise operations for outputting a synchronization signal enabling acquisition of the image.

6. The image reading apparatus according to claim 5, wherein
the predetermined count threshold value corresponds to a position at which the carriage reads a shading plate.

7. The image reading apparatus according to claim 1, further comprising:
a sensor configured to detect a position of the carriage, wherein
the processor stops the stepping motor based on a signal from the sensor.

8. The image reading apparatus according to claim 7, wherein
the processor stops the stepping motor if the carriage is moved to a predetermined initial position.

9. The image reading apparatus according to claim 1, wherein
the first clock signal is generated by a CPU clock, and
the second clock signal is generated by a DMA clock.

10. An image reading method, comprising:
outputting a first clock signal for driving a stepping motor for moving a carriage for acquiring an image if a position of the carriage is not a predetermined position; and
outputting a second clock signal having a frequency higher than that of the first clock signal for driving the stepping motor if the position of the carriage is recognized.

11. The image reading method according to claim 10, further comprising:
using the first clock signal in a closed loop control; and
using the second clock signal in an open loop control.

12. The image reading method according to claim 10, further comprising:
setting the configuration of a second clock and outputting the second clock signal in accordance with the configuration.

13. The image reading method according to claim 10, further comprising:
generating the first clock signal, counting the first clock signal and executing predetermined operations if the count number of the first clock signals is coincident with a predetermined count threshold value during outputting of the second clock signal.

14. The image reading method according to claim 13, further comprising:
outputting a synchronization signal enabling acquisition of the image.

15. The image reading method according to claim 14, wherein
the predetermined count threshold value corresponds to a position at which the carriage reads a shading plate.

16. The image reading method according to claim 10, further comprising:
detecting a position of the carriage, wherein
stopping the stepping motor is based on a signal from a sensor.

17. The image reading method according to claim 16, further comprising:
stopping the stepping motor if the carriage is moved to a predetermined initial position.

18. The image reading method according to claim 10, further comprising:
generating the first clock signal by a CPU clock, and
generating the second clock signal by a DMA clock.
